(19) United States
(12) Patent Application Publication
(10) Pub. No.: US 2008/0191895 A1
(43) Pub. Date: Aug. 14, 2008

(54) Microscope with a Display

(76) Inventors: Ralph Aschenbach, Hardegsen-Hevensen (DE); Thomas Bocher, Goettingen (DE); Matthias Kramer, Goettingen (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 11/886,014

(22) PCT Filed: Jun. 1, 2006
(86) PCT No.: PCT/EP2006/005218

§ 371 Date: Sep. 10, 2007

(30) Foreign Application Priority Data
Jun. 22, 2005 (DE) 10 2005 029 672.6

(51) Int. Cl. G08B 5/22; G08B 5/00

(52) U.S. Cl. 340/815.42; 340/815.45; 340/815.4

(57) ABSTRACT

The invention is directed to a light microscope with a display which is suitable for use particularly in lecture rooms or dissection rooms. By an integrated, large display of the viewing conditions, e.g., lamp voltage, selected objective, etc., that can be viewed from a distance, the actual state of the adjusted conditions can be determined from any position within a classroom or laboratory room.

### CROSS-REFERENCE TO RELATED APPLICATIONS

This application claims priority of International Application No. PCT/EP2006/005218, filed Jun. 1, 2006 and German Application No. 10 2005 029 672.6, filed Jun. 22, 2005, the complete disclosures of which are hereby incorporated by reference.

### BACKGROUND OF THE INVENTION

a) Field of the Invention

The invention is directed to a light microscope with a display which is suitable particularly for use in lecture rooms or dissection rooms.

b) Description of the Related Art

It is conventional to provide the user of a microscope with information regarding the status of settings such as illumination, magnification, selected contrast mode, and so on, by means of optical displays.

Aside from displays, sight windows and lettering on optical elements, illuminated areas which may be made up of, e.g., a plurality of LED elements which are selectively turned on or which can also be controlled with respect to brightness are also used for this purpose. For example, the “Axioplan 2” microscope by the present Applicant uses a light chain of LEDs which emit in the direction of the user to show the voltage and, accordingly, the brightness of the illumination.

DE 103 26 696 describes a microscope with an integrated display in which parts of the housing are constructed so as to be transparent in order to allow the user to view displays arranged in the housing.

DE 102 06 227 describes a microscopy laboratory device which comprises a plurality of simple microscopes, each of which is outfitted with a video camera and in which video multiplexers are provided for displaying the image of one or more video cameras on a screen. For this purpose, the video cameras of the microscopes are connected by cable or wirelessly to a central unit in order to deliver the image signal of the video cameras to this central unit. In this way, a lecturer can comment on the images received at the individual microscopes and display them on the screen to be viewed by all. As is generally known, the quality of a microscope image of this kind depends substantially upon the selected adjustment of the viewing conditions at the microscope. In spite of the substantial technical resources required in the described solution, it is not possible for the lecturer to monitor these conditions or correct them should the need arise.

### OBJECT AND SUMMARY OF THE INVENTION

It is the primary object of the invention to make it possible for a lecturer or the like to discern and monitor the viewing conditions at a plurality of microscopes from a distance.

This object is met, according to the invention, in a microscope with at least one display for displaying microscope functions such as lamp voltage, brightness of illumination, position of an objective turret, or the like, wherein the display is arranged in such a way that it is visible from a position in front of and/or to the side of and/or in back of and/or above the microscope.

By means of an integrated, large display of the viewing conditions that can viewed from a distance, the actual state of the adjusted conditions can be determined from any place within a classroom or laboratory room.

According to the invention, this is achieved in that the display comprises light sources such as, e.g., LEDs or OLEDs, and an element which covers the light source and which also serves to distribute laterally the light emitted by the light source. This can be accomplished by reflection of the light within the cover element, by dispersion or by diffraction by means of diffractive optical elements by means of which the light is deflected toward the sides and/or to the rear. Further, the cover element can be constructed so as to be elevated above the wall of the microscope stand in order to improve the visibility of the display from more than one side. Alternatively, a portion of the microscope housing can also be constructed in a manner known per se so as to be transparent so as to make a quantity of light sources visible also from the sides or from the back. In so doing, the light is emitted at a solid angle greater than 90°, preferably greater than 120°.

The displayed microscope functions which advantageously characterize the viewing conditions can include the lamp voltage, the position of the objective turret, the position of the reflector turret, the height and position of the microscope stage, laser safety indications, or other functions which are relevant for and controllable by the microscope. In addition, the individual light sources can differ in shape, color, arrangement, quantity, or the like for purposes of associating the display with the respective microscope function. Accordingly, it is possible to designate the meaning of the display of a series of additional light sources through signaling by means of a colored light source so as to facilitate or enable interpretation of the display for the lecturer from a distance. The meaning of the display can be changed by means of an operating control at the microscope.

In a particularly advantageous manner, a remote control can be provided at the microscope so that the lecturer can change the respective meaning of the display from his/her location by means of this remote control. This remote control can be carried out in a manner known per se wirelessly (e.g., by radio, infrared, WiFi, WLAN, etc.) or by cable.

The invention will be described more fully in the following with reference to the drawings.

### BRIEF DESCRIPTION OF THE DRAWINGS

In the drawings:

FIG. 1 shows a side view of a preferred embodiment form of the invention;

FIG. 2 shows an oblique front view of the preferred embodiment form of the invention;

FIG. 3 shows an oblique rear view of the preferred embodiment form of the invention; and

FIG. 4 shows an oblique front view of a second embodiment form of the invention;

FIG. 5 shows a detail of the display according to the invention.

### DESCRIPTION OF THE PREFERRED EMBODIMENTS

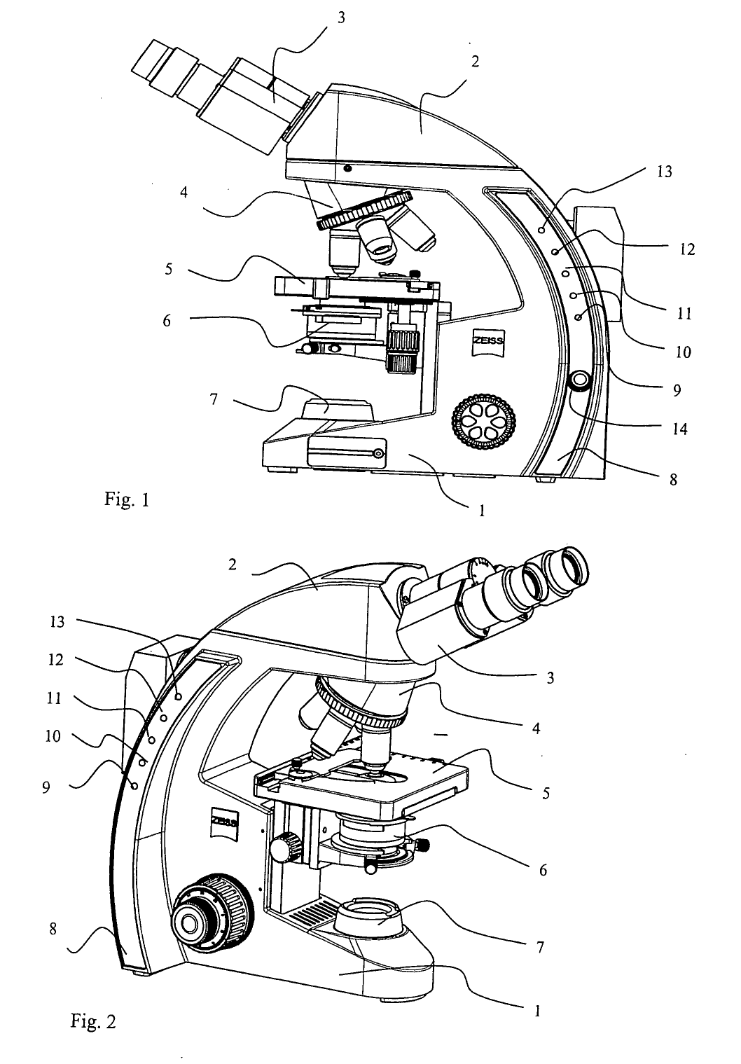

FIG. 1 shows a microscope with a stand 1, tube 2, binocular part 3, objective turret 4, object stage 5, condenser 6, and a transmitted light illumination 7. The stand 1 has a projection 8, 8′ on each side at which a series of light sources 9, 10, 11, 12, 13 is arranged in such a way that they can also be seen by persons positioned to the sides of or behind the microscope. In the simplest embodiment form, the light sources 9 to 13 show the brightness of the transmitted light illumination 7 which can be adjusted by means of the rotary knob 14 in six steps (step 0—lowest brightness—none of the light sources 9 to 13 is lit until step 5—highest brightness—all of the light sources 9 to 13 are lit). It is also possible to display intermediate stages of the brightness of the transmitted light illumination 7 by varying the brightness of the light sources (e.g., light source 9 and 10, full brightness, light source 11, 50% brightness, would display a step 2.5 of the brightness of the transmitted illumination).

In a second mode of operation, each of the light sources 9 to 13 can be associated with a turret position of the objective turret 4 and can accordingly show the position number of the respective objective 15 located in the beam path (light source 9 for turret position 1, light source 10 for turret position 2, and so on).

In an analogous manner, other microscope functions or microscope states such as the position of a reflector turret, not shown, or a stage position, etc., can also be displayed.

For purposes of illustration, FIG. 2 shows an oblique view of the preferred embodiment form of the invention, wherein the reference numbers have the same meaning as in FIG. 1.

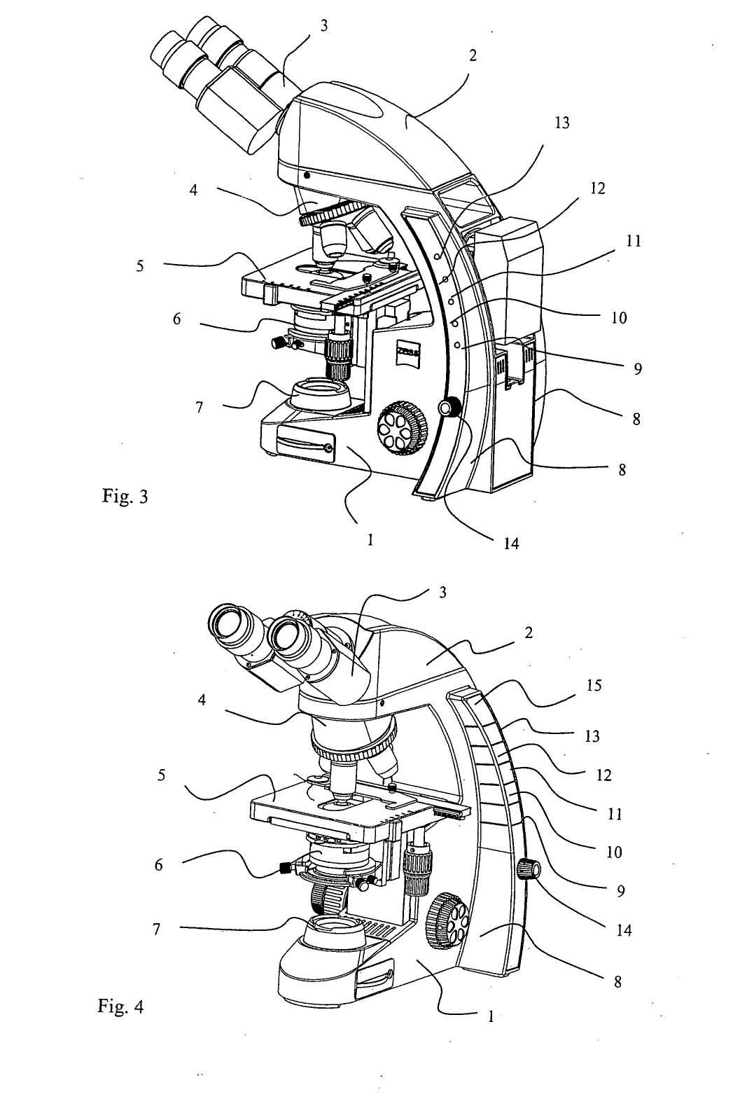

FIG. 3 shows an oblique view from the rear in which the reference numbers likewise have the same meaning as in FIG. 1. FIG. 3 shows that the display by means of light sources 9 to 13 can also be seen from the back of the microscope.

FIG. 4 shows an alternative construction of the light sources 9 to 13 by illuminated surfaces which at least partially cover the surface of the projection 8. It is also possible to construct the projection 8 so as to be partially transparent and to arrange the light sources 9 to 13 in the interior of the projection 8 so that the display is carried out through the transparent parts of the projection 8. This second embodiment form of the invention has another light source 15 by means of which the respective meaning of the displays 9 to 13 can be shown, e.g., by means of different colors.

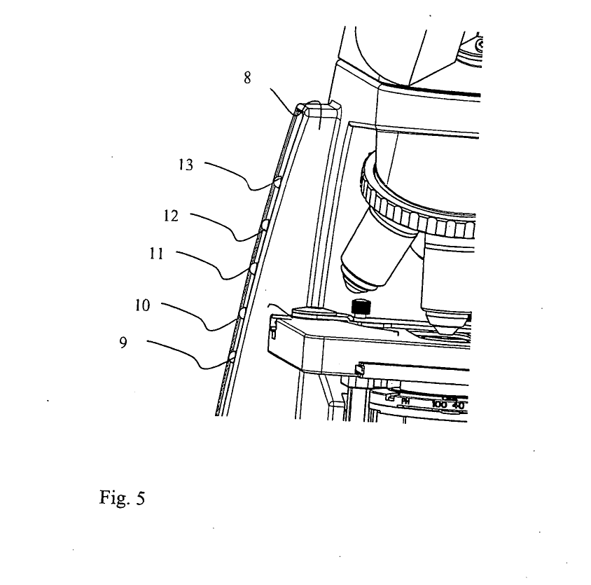

FIG. 5 shows an enlarged section of the preferred embodiment example and illustrates how the light sources 9 to 13 project out over the surface of the projection 8 to ensure visibility from a large area surrounding the microscope. Accordingly, a lecturer or another person in charge of instructing the user of the microscopes can read the display from a long distance and from any position relative to the microscope and can correct the user when the microscope is incorrectly adjusted.

In principle, any light sources, but preferably LEDs or OLEDs, can be used as light sources 9 to 13 and 15.

The invention is not limited to the embodiment examples shown herein. Further developments by those skilled in the art do not constitute a departure from the protective scope defined by the claims.

1-13. (canceled)

14. A microscope comprising:
at least one display for displaying microscope functions such as lamp voltage, brightness of illumination, position of an objective turret, or the like, wherein the display is arranged in such a way that it is visible from a position in front of and/or to the side of and/or in back of and/or above the microscope.

15. The microscope with a display according to claim 14, wherein the display comprises at least one light source and a cover, wherein the cover distributes the light coming from the light source in different spatial directions.

16. The microscope with a display according to claim 15, wherein the distribution of the light is carried out by means of reflection within the cover.

17. The microscope with a display according to claim 15, wherein the distribution of the light is carried out by means of dispersion within the cover.

18. The microscope with a display according to claim 15, wherein the distribution of the light is carried out by means of fluorescence within the cover.

19. The microscope with a display according to claim 15, wherein the distribution of the light is carried out by means of diffraction within the cover.

20. The microscope with a display according to claim 14, wherein the light source is an LED.

21. The microscope with a display according to claim 14, wherein the light source is an OLED.

22. The microscope with a display according to according to claim 14, wherein the light source is a laser diode.

23. The microscope with a display according to according to claim 14, wherein the light source is a fiber-optic laser.

24. The microscope with a display according to according to claim 14, wherein the display is segmented.

25. The microscope with a display according to claim 14, wherein the display can be switched to display different microscope functions.

26. The microscope with a display according to claim 25, wherein the respective switching state of the display is signaled optical.
